(19) United States
(12) Patent Application Publication
(10) Pub. No.: US 2001/0044834 A1
(43) Pub. Date: Nov. 22, 2001

(54) Method and apparatus for automatically deploying data in a computer network

(76) Inventors: Robert Bradshaw, San Jose, CA (US); Kevin Cochrane, San Francisco, CA (US); William G. Cuan, Sunnyvale, CA (US); Britt Park, Mountain View, CA (US)

Correspondence Address: David R. Stevens, Stevens & Westberg LLP, Suite 201, 99 North First Street, San Jose, CA, 95113, US

(21) Appl. No.: 09/815,496

(22) Filed: Mar. 22, 2001

Related U.S. Application Data
(60) Provisional application No. 60/192,244, filed on Mar. 22, 2000.
(60) Provisional application No. 60/205,805, filed on May 17, 2000.

(51) Int. Cl. G06F 15/16; G06F 15/167

(52) U.S. Cl. 709/217; 709/213

(57) ABSTRACT

A method and apparatus is provided for automatically deploying data within a website development software application. More particularly, the invention is directed to the automatic retrieval of data upon occurrences of certain events from different sources associated with such a website application during its use and operation. A system that utilizes the invention may work in synchronicity with the application to retrieve and store data that is created, modified or otherwise changed. Unlike other solutions, the automatic synchronization features of the invention provide the ability to retrieve and store data in a manner that is transparent to a user, such as a website developer, giving the user the freedom to develop or maintain a website without concerns over whether and where data may be stored.

### RELATED APPLICATIONS

This application claims the benefit of U.S. Provisional Application No. 60/192,244, filed Mar. 22, 2000; U.S. Provisional Application No. 60/205,805, filed May 17, 2000; U.S. patent application Ser. No. ______, filed on the same day as this application, and entitled, “Method Of And Apparatus For Recovery Of In-Progress Changes Made In A Software Application,” and U.S. patent application Ser. No. ______, filed on the same day as this application, and entitled, “Method and Apparatus for Storing Changes to File Attributes Without Having to Store an Additional Copy of the File Contents,” are hereby incorporated by reference.

### BACKGROUND

The invention relates generally to the deployment of data in computer networks and, more particularly, relates to a method and apparatus for automatically deploying data to certain locations when data is transmitted or otherwise changed in conjunction with content development application.

Applications specifically tailored to developing Internet websites are well known in the website development industry. Many of these applications offer simplified methods for designing and maintaining a website such as receiving, storing, arranging and delivering information within a website. In more advanced systems, information must be stored in multiple locations and in different files so that other advanced functions of the application program can operate and have access to certain information.

It is often a challenge to develop large websites due to the need to coordinate the efforts of many contributors. As a result, modern website development tools have been developed that enable multiple workstations to concurrently create website content. Furthermore, many websites need to be frequently modified, and contributors usually modify them in an ad hoc process. Problems occur when users from separate workstations try to update the same information on a website, confusing the process. Propounding the problem, many businesses require that their Internet sites be updated by the day, hour or minute, and by numerous contributors. And, as the number of contributors increases, so does the volume, and complexity of content, as well as its use. As information is created, it must be saved by all of these contributors, who may or may not be diligent in maintaining proper data preservation procedures. As a result, managing the website for efficiency and quality control has become difficult.

In response to these problems, system applications have been developed for managing website development. Some of these include software configuration management systems, document management systems and database publishing systems. In one such application, websites may be developed within work areas where individual website developers construct or maintain separate portions of content that define a website. This helps to spread out the tasks of website development to multiple people. The final contributions from each developer may then be incorporated into the final website.

There are several disadvantages associated with such known website development systems. For example, where maintaining a website may require the efforts of large numbers of people, it may be desirable to have website contributors work in parallel. Software configuration management systems do not allow contributors to simultaneously make changes to the same area of a website. And, conventional systems typically do not allow individual contributors to separately test their own work without publishing to the website. The result is that individual contributors cannot foresee the effects of their contributions when combined with other contributions. As a result, conflicting changes may be posted to a website, corrupting its content and undermining the website's integrity.

Conventional systems sometimes rely on a central website control person known as a “webmaster” to integrate all changes posted to a website. This webmaster is solely responsible for the quality control of the website and for integrating all of the content. With the existence of multiple content contributors, the webmaster often becomes a bottleneck in maintaining and developing websites. Integrating the work of multiple contributors is a time consuming and labor intensive task, and includes debugging the content and resolving conflicts among contributors. To further complicate things, webmasters have no real-time control over the contribution process. This makes it difficult if not impossible for the webmaster to properly organize and maintain a website. The webmaster is left to sort through errors, to resolve conflicts and to schedule website changes after the content is delivered.

Such a system requires that information be stored in multiple locations, within many different files and within a format where the information can be easily accessed and cross referenced within the application. Conventional applications require a user to manually submit and store information into some location. If a user desires submissions or storage into multiple locations, they are usually done individually, leaving the user the extra task of deciding proper storage locations to store data, and the responsibility of manually storing the information. In either case, the deployment of information requires arduous tasks that detract from the principle purpose of the development software, developing websites.

Therefore, there exists a need in the website development industry for a method and apparatus for more efficiently deploying and storing data within website development applications. As will be seen, the invention accomplishes this in an elegant manner.

### SUMMARY OF THE INVENTION

The invention is directed to a method and apparatus for automatically deploying data within a website development software application. More particularly, the invention is directed to the automatic retrieval of data upon occurrences of certain events from different sources associated with such a website application during its use and operation. A system that utilizes the invention may work in synchronicity with the application to retrieve and store data that is created, modified or otherwise changed. Unlike other solutions, the automatic synchronization features of the invention provide the ability to retrieve and store data in a manner that is transparent to a user, such as a website developer, giving the user the freedom to develop or maintain a website without concerns over whether and where data may be stored. These and other features of the invention will be apparent in detailed description below.

### BRIEF DESCRIPTION OF THE DRAWINGS

FIG. 1 illustrates a computer network system for website development in accordance with the present invention;

FIG. 2 illustrates a development system in accordance with the present invention;

FIG. 3 illustrates a development system in accordance with the present invention;

FIG. 4 illustrates a development system in accordance with the present invention;

FIGS. 5A and B illustrate a development system in accordance with the present invention;

FIG. 6 illustrates a tracker table in accordance with the present invention;

FIG. 7 illustrates a development system in accordance with the invention;

FIG. 8 illustrates a development system in accordance with the invention;

FIG. 9 illustrates a flow diagram for operation a deployment technique in accordance with the present invention; and

FIG. 10 illustrates a block schematic diagram of elements used for deployment in accordance with the present invention.

### DETAILED DESCRIPTION

The invention is directed to a method and apparatus for efficient storage and deployment of data. A system that utilizes the invention may work in synchronicity with the application to retrieve and store data that is created, modified or otherwise changed. The deployment and storage of the data may also be automatic, making the operations operate in the background of an application where them transparent to the system operators. In one embodiment of the invention, a computer system may be configured to execute software code that defines the relevant functions for performing data retrieval and storage operations according to the invention.

One embodiment of the invention may be characterized as a record oriented data pump application that reads data content records (DCRs) from a source upon an event. The pump may be configured to trigger a retrieval action upon the occurrence of an event, a trigger event, and possibly perform a subsequent or concurrent action, depending on the type of event. The data pump may then store, modify, transfer, filter, write a result to a destination or otherwise change the data according to predetermined parameters. The invention is particularly adapted to deploying data in an Internet website development software application and will be described in that context. It will be appreciated, however, that this is illustrative of only one utility of the invention, and that the invention has greater applicability and utility.

In a website development application, events that relate to changes in data may take on many forms. For example, when data is created in a work area, it is important to somehow capture that data and preserve the changes in the application data associated with its creation. Other examples include transferring data to destinations, changing actual content to be displayed on a website, changing attributes of a file that may affect the use of the content within the file, and other actions that are related to content, attributes and other records and data related to the development and maintenance of websites. The invention is directed to the efficient retrieval, deployment and storage of these types of data, the operation of which may be automatic and synchronous with the underlying application wherein the data is used.

In a computer system that manages a quantity of data, the data is stored in computer memory in the form of files. For example, in a system for maintaining and making changes to content for a website, extranet site or intranet site, physical memory may be allocated for work areas, staging areas and edition areas. Work areas may store in-progress changes to be made to the content by an individual contributor or group of contributors. Unlike conventional systems, a system embodying the invention may be configured to automatically retrieve, deploy and store these in-progress changes in a manner that is transparent to users maintaining and developing content. Once the changes are made in the work areas, the changed content may be submitted to a staging area or areas.

In the staging area, the content changes may be combined. From the staging area, the changed content may be forwarded to an edition area or areas. The edition areas may store versions or editions of the content for the website, extranet site or intranet site.

In addition to the memory that may be allocated for the various purposes described above, a physical backing store memory may also be provided for providing persistent storage for changes and other content. By persistent, what is meant is that the contents of the backing store are preferably saved despite a shutdown or power failure occurring to the system of which the backing store is a part. In order to preserve in-progress changes, the invention is directed to the automatic retrieval, deployment and storage of such data in a manner that is transparent to a user.

Because the website, extranet site or intranet site may allow access to a large quantity of data, including, for example, text, graphics and audio information, the backing store memory may need to store a large quantity of data. This especially true considering that the backing store may store work-in-progress and multiple editions or versions of content for the website, extranet site or intranet site. For example, the backing store memory may be required store up to three times or more the size of the entire content of the website, extranet site or intranet site.

Files in the backing store or other memory each include contents and attributes. The contents of a file include the information stored within the file. This may include, for example, the text, graphics and audio information which is to be accessible via the website, extranet site or intranet site. The attributes of a file (the attributes may also be referred to as “metadata”) include information relating to the file. This may include, for example, the size of the file contents, a time stamp indicating when the file was created or when the file contents were last changed, an identification of an owner who is the contributor responsible for the file, an identification of a group to which the file or its owner belongs and permission information for restricting access to the file for performing read and write operations on the file. This information may be as critical as content for integrating content created in one work area with content created in another area. The invention is directed to the storage of this data in an efficient manner.

The attributes of a file are stored, such as in the backing store, in association with the content of the file. When a change is made to the file contents, both the changed version of the file contents and the version prior to the changes may be stored in the backing store. For each version of the file contents, associated attributes are also stored. Because the attributes may include the size of the file and a time stamp indicating when the file was last changed, changes in the file contents generally result in changes to the attributes. Accordingly, a different set of attributes is stored for each version of the file contents. For a system to operate optimally, these attributes must be stored continuously, automatically and synchronously with the system. The invention is directed to doing just that.

However, when a change is made to the attributes of the file without a change to the contents of the file, the newly changed attributes may be stored, such as in the backing store, along with the prior version of the attributes. The newly changed attributes and the prior version of the attributes then share the same version of the file contents. In this way, multiple versions of attributes may be associated with a single copy of file contents. Thus, storage space in the backing store may be preserved since storage of a separate copy of the file contents in association with each version of the file attributes is avoided. A pointer may be provided, such as in the backing store, which links both the newly changed attributes and the prior attributes to the same copy of the associated file contents.

In one embodiment of the invention, a solution is configured to develop and maintain Internet websites. Throughout such a system, data may need to be stored while the website is developed and maintained. In prior art systems, a user would be required to manually store data as it is created and maintained. Utilizing the invention, however, data may be automatically retrieved, stored and possibly modified according to certain parameters, transparent from the user.

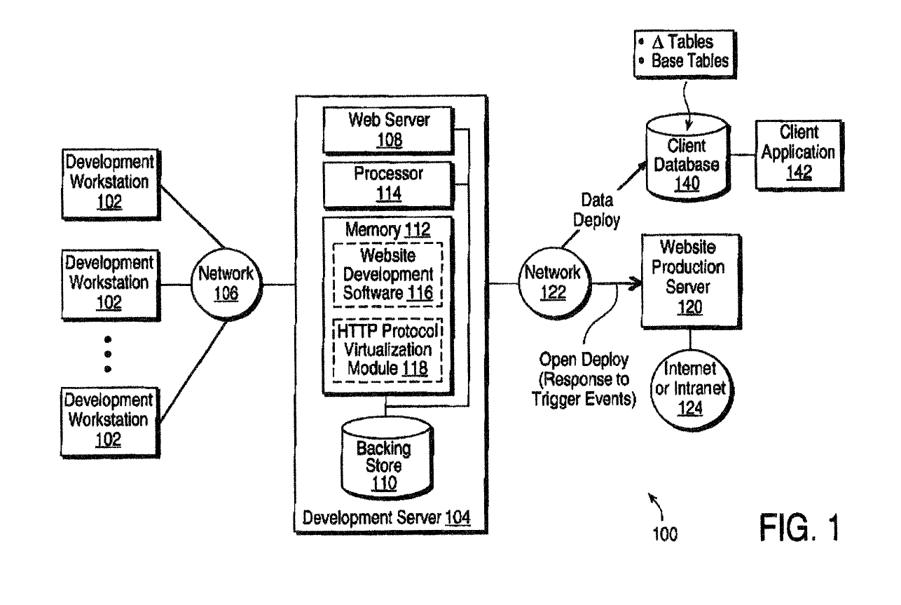

The application may include staging areas wherein data is stored and presented. Referring to FIG. 1, a block diagram of such an application is shown. The website is maintained by users occupying workstations 102. The users develop particular areas within the website in work areas, which are stored separately from other areas. Once a user working within a work area has completed a task for the website, the user may submit the content to a staging area for review. The staging area is configured to hold information pertaining to areas within the website from the multiple work areas. The proposed changes to the website can be displayed at the staging area for review before they are published in the final website. Once the changes are approved at the staging area, the changes are published and the website is modified.

In order to perform this functionality, data must be stored in a database throughout the development process. Referring again to FIG. 1, a development server 104 gives access to a database for each stage of web development. This configuration allows the storage of data taken or sent from each stage. Since the website itself is not modified directly, tables of data may be established in order to temporarily and separately store changes made in a work area. Base tables may be developed to store the data currently published on the website, giving each work area a base on which to modify the information. Delta tables may be developed and associated with a particular work area to store proposed changes to the website relative to the base tables. When a user makes changes with in a particular work area, the changes can be stored in the respective delta table. Subsequently, the changes made in the work area can be submitted to the staging area, where proposed changes from all work areas can be viewed. The staging area holds the combination of the base table and the delta tables submitted by the individual work areas. These changes are stored in the database separately from the delta tables themselves so that they can be separately updated. Similarly, when the information in the staging area is published for display on the website, the website data, stored separately in the database, is modified accordingly.

In order to store particular information properly, a user utilizing conventional methods typically must compile the changes created in a work area into a file and store the file in the database. Taking into account the voluminous and varied information produced in a work area, this can be an arduous task, requiring considerable time to execute. Of course, this takes precious time away from the task of producing and maintaining a website.

According to the invention, the problem of storing information is all but eliminated. Certain events occurring in the work area may be automatically saved and possibly modified, the operation of which may be transparent to the user. For example, content and related data, when transferred to a staging area, may be automatically updated in order to preserve the change in the data, as well as preserve the older versions of the data. This allows the user to continue on website development tasks without having to worry about and waste time with organizing and properly storing data. In its application in an actual software application, this improvement has been proven to greatly streamline the website development process.

In order to understand one embodiment of the invention related to website development and maintenance solutions, it is useful to understand an example of such a solution. FIGS. 1-7 illustrate such an example of such a system. Referring to FIG. 1, a computer network system 100 for website development is illustrated. In one or more development workstations 102, website developers may add, remove, edit and examine files for a website. Development workstations may include conventional personal computers, UNIX workstations, or other workstations that can be configured to develop content. The development workstations 102 may be connected to a development server 104 via a computer network 106, such as the Internet or LAN.

The development server 104 may include a web server 108 for serving up content to web browsers, and a backing storage 110 for storing versions of website content. The server 108 processes HTTP requests from the development stations 102 for website content (e.g., files). The website files may be physically stored in the backing store 110 which may be conventional, such as the WINDOWS NT filing system commercially available from Microsoft Corporation. The backing store may serve as a central location to store all data that is created, transferred, or otherwise maintained within the system. According to the invention, storage of data may be executed transparent to the user.

The development server 104 may also include a conventional memory 112 (e.g., RAM) and a conventional processor 114, which implements the website development methods of the present invention by executing software code 116 stored in the memory 112. An HTTP protocol virtualization module 118 may be executed by the processor 114, allowing web server 108 to operate as if it were multiple servers. The module may also be stored in the memory 112. The development server 104 may be coupled to a website production web server 120 via a network 122. Network 122 may be the same network as network 106 or a different network. The web server 120 may also be coupled to the Internet or an intranet 124. When a website is ready to be posted on the World Wide Web or on an intranet, the development server 104 sends the website content to the production web server 120 which then provides Internet or intranet access to the website, depending on the system configuration. Network 122 may deploy data to client database 140 that originated in development server 104. A base table may be established in client database 140. The base table may be a snapshot of a staging area located within development server 104. These base tables may be updated as the staging area changes via further data deployments. The database services client application 142, which may make changes in order to maintain its own website or other application that the development server services. In this respect, delta tables may be established in database 140 to preserve changes that users may make in client application 142. In one respect, the delta tables and base tables operate along with the client application similar to the function of the development workstations 102 that send changes to staging areas. In this respect, the client application may act as the workstation, and the delta and base tables act as the staging area. The benefit to this configuration, is that maintenance of a website may be under the control of the development server, or may be separately under the control of the client application in conjunction with the client database.

A website is generally comprised of the contents of an arbitrary file system. The website development system 100 of the present invention may include hierarchical file systems. Each such file system of the present invention provides an environment for managing and manipulating individual files. When executed, the website development software 116 enables the management and manipulation of files. The backing storage 110 is where the files and corresponding metadata may be physically stored. Metadata is generally data that is related to work content. Some examples include for example content owner identification, group identification, access control, file name, modification times, creation times, extended attributes (EAs), website addresses associated with the content, and other information related to the content.

A hierarchical file system of the present invention may be referred to in the art as an “area.” There may be different types of areas including work areas, staging areas and edition areas. A work area may be a modifiable file system that is used by persons who create and maintain web content in work files for eventual use in a website. A staging area may be an area where content from these work files is assembled before it is published. A central control person, such as a webmaster, may edit content submitted from work areas within a staging area or an edition area. Since the work areas are generally areas for creating and maintaining content exclusively, the staging and edition areas may be restricted to only assembling and displaying content. By design then, they may be configured as read-only file systems. Any modifications to content may then possibly need to be sent from an editor back to a workstation to perform any changes that may be needed. This helps to maintain the integrity of the content and to simplify the process. However, a business may want the system 100 to be more flexible, allowing other people such as editors to modify the content before it is published. The staging and edition areas may then be configured as modifiable file systems. In either case, the automatic storage and possibly modification of data upon the occurrence of certain events may be desired in order to preserve data produced or otherwise modified during development or maintenance of a website. This way, different versions of content may be preserved and time-stamped, allowing developers and possible editors and administrators the ability to revert back to different versions of the content.

For example, content may be submitted to a staging area for review. Upon the occurrence of the submission of data, metadata associated with such content may be modified in order to distinguish the changes made from the original version. This way, different versions may be preserved and organized. To save space, only the deltas, or actual changes may be stored from each version. This can be useful in the day-to-day operations of a website. For example, an airline may advertise different fares online, to which purchasers may order tickets for flights. An error in publishing a fare may occur, such as a fare that is much lower than planned, giving purchasers a windfall. A website administrator may then revert back to the earlier website, and avoid losing money by selling too many low fares. Having older versions of content, therefore, may be crucial to certain businesses.

A work area may initially include a virtual copy of an entire website, unless there is no existing website, in which case the work area may be empty. In other words, a work area may initially have the same contents as the file system designated for the website. A work area provides a developer's personal view of a website in which the developer may contribute to the website. For example, in a work area, developers can freely add, delete and modify website content and see how their changes fit into the context of the entire website. Changes made by developers in work areas preferably do not affect the website or the work of other contributors in other work areas. This is because each work area may be configured as a separate file system. Typically, a work area is located at one or more workstations 102.

Developers may integrate their work in a staging area by submitting the contents of their work areas into a staging area. This action is referred to as an internal deployment, or simply as data deploy™, where data is transferred to a backing store, which contains file versions of web content. The staging area is a file system available to multiple developers that provides a shared view of the website. Thus, a staging area may hold the collective work of several developers' work areas and may allow the developers to share and integrate their changes. In a staging area, the developers can see how their changes fit together. The staging area is typically located at the development server 104. According to one embodiment of the invention, upon submission of the content from a work area to a staging area, content related attributes might be automatically stored, and even modified to upon such an event in order to preserve versions of content. This operation may be executed transparently to the user, working in synchronicity with the development system.

Copying is said to be “virtual” where areas share directory trees, but are configured such that the directory trees do not need to be physically copied. In operation of the software application, the collective work in a staging area changes as different contributors submit new content from work areas. Work areas are most effective when the content and other information in the staging area is virtually copied back to one or more private work areas. This helps to keep the individual work areas up-to-date with respect to the staging area while contributors are performing website related tasks such as creating and maintaining content.

When the collective work in a staging area is deemed final, its contents can be published to create an edition of the website. According to the invention, deployment may occur upon certain events, which may be followed by the storage of either content or metadata. The retrieval and preservation of this data may be done automatically, and synchronously according to the invention. This may be accomplished by virtually copying contents of a staging area onto an edition area. Because an edition is typically a read-only file system, it is a frozen snapshot of the content of the entire website. Each edition taken at sequential points in the development of a web site may be archived and accessible to all developers so that developers may instantly recall files, entire directories, or reconstruct entire past versions of the website. For example, the contents of an edition may be virtually copied into a work area to be used as a basis for further development of the website. An edition area is typically located in the production server 120. The invention provides for the deployment of such data so that virtual copies of information will be available for workstations.

So that the website development and maintenance work progresses in a predictable and orderly fashion, tasks are assigned and performed in accordance with a workflow, also known in the industry as a “job”. The workflow configuration, or job, is a calculated arrangement of tasks to be performed. The arrangement may include tasks performed in serial order, in parallel with each other or in combinations of serial and parallel operation. A workflow model is a general workflow configuration that can be used repeatedly. Each workflow model describes a process that can include user tasks as well as a wide variety of automated tasks. Workflow models are typically designed by business managers and configured by a system administrator. The present invention provides the ability to enable a workflow configuration to be organized and managed according to the criteria established within the system. One embodiment of the invention is directed to the preservation of different versions of the content according to associated metadata and attributes that are associated with the file containing the content.

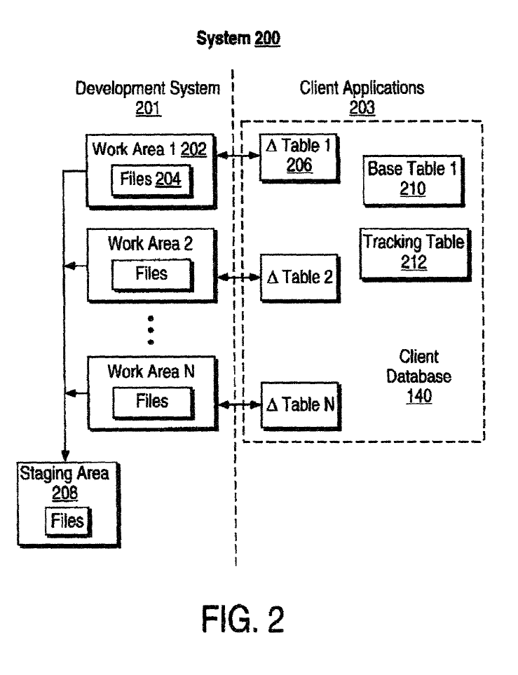

Referring to FIG. 2, a general block diagram of a website development system is illustrated in terms and figures related to locations where files are created and maintained. In one embodiment, the system 200 is divided up into separate sections, the development section 201 where content is created and maintained in conjunction with a development server, and client applications 203 where content is created and maintained in conjunction with a separate client application as discussed above. In either application, the control of the changes made to content is located in different locations. The client applications may also depend on content maintained in staging area 208 containing integrated content files in the development system in order to keep its base table 210 updated. In one embodiment, the staging area may be the dominant location where fundamental changes reside, such as templates, unchanging content, and other information. Depending on the configuration, either the work areas or the client application, or both, may produce content for ongoing maintenance of website files. The work areas 202 and delta tables 206, located in database 140 of FIG. 1, may be indirectly related, where changes may be recorded in either location depending on the system configuration.

These files are created and maintained in different ways to accomplish certain results related to the development and maintenance of websites. As will be seen, the manner of storage and transmission of website content, attributes of a file containing content, and other data can be crucial to efficient and convenient development and maintenance of a website. The invention is directed to a method and apparatus for accomplishing just that by facilitating the useful presentation of data by storing different versions of content automatically and in synchronously with the development application. In the system illustrated in FIG. 2, a first work area 202 includes memory for temporarily storing files 204. The files 204 define the portion of the website to which the user of the work area 202 is contributing as well as the changes the user is making. The files may include content and file attributes related to such contributions. In communication with the work area 202 is a table 206, referred to herein as a delta table. The delta table 206 may be a location in memory or a memory device itself that is configured to store data related to indicia of changes made by the user in a client application. Work area 202 is in communication with a staging area 208, which is configured to allow a user to submit contributions for staging display with other website content. As also illustrated, a number of additional work areas (work areas 1-N) may be associated with the system. Each work area may include a delta table (delta tables 1-N), which each may be in communication with the staging area 208. These allow one or more users to operate in separate work areas to develop content and stage their contributions along with content from other work areas. According to the invention, delta tables may be configured to store changes in the content and separately in the attributes of a file. This gives the delta tables the ability to preserve different versions of the content from the different work areas, possibly within a client application, and other areas according to changes made. This may be an advantage if the system is configured to store the changes themselves, rather than whole entire versions of content, saving precious storage area.

In the staging area 208, individual contributions from the various work areas may be organized, combined with other content, and tracked as it changes over time throughout the system. Base table 210 may be a storage area a client application that maintains indicia of a base website configuration, such as an original version before it is modified in one or more workstations. This gives each work area in a client application a baseline from which to add, delete or otherwise modify content. The information maintained in the delta tables is with respect to the original website configuration information maintained in the base table 210. Thus, the contents of the base table 210, taken in combination with the contents of the delta table 206, specifies the website as modified in the client application. The staging area and base table 210 correlate in function, where the staging area stores the integrated contributions of the work areas, and the base table is a mirror of the staging area. The contents of the staging area may be transferred to the base table to establish updated base information for a client application.

In operation, a user in work area 202 may download a file or files containing some or all of the current data appearing on a website. This data file may include content, metadata, extended attributes and other data related to contend. The content is the work product of the user in a work area, and metadata is information related to the content that defines its use and gives the system the ability to categorize the content according to its intended use. An extended attribute is information attached to a file that is representative of information contained in the file. Utilizing this data, the system may track, store and organize versions of content according to different parameters, such as creation dates, locations of websites, locations of work areas, previous deployment dates and other information. Producing this data automatically according to certain events, a development application can perform work on content both automatically and transparent to the user. The downloaded file or files may be considered a type of “snapshot” of the website as it exists at a particular time. The user of work area 202 may then perform one or more tasks which result in changes to the website snapshot. According to the invention, the changes with respect to the snapshot may be automatically recorded in staging area 208. Similarly, a user in a client application may also perform one or more tasks which result in changes to the client's website snapshot. According to the invention, the changes with respect to the snapshot may be automatically recorded in the client's delta tables.

Once the user's task is completed, the user can submit the proposed changes to the staging area 208. The changes may then be submitted to client base table 210. Such a submission must necessarily work in synchronicity with the client application to provide useful updates to the client content located in the client database. According to the invention, upon submission to the staging area and base table, metadata may be modified to reflect the change in versions of content. Once the content is submitted to the staging area, a decision is then made by a decision-making authority (e.g., a designated “webmaster”) as to whether to incorporate the changes so as to update the final website in response to the changes.

The user of the work area 202 or a work area of a client application may also update its snapshot of the website by requesting an update from the staging area 208. Depending on the circumstances, this update may affect the user's snapshot of the website in a number of different ways. In one embodiment, changes made to the website in other work areas are incorporated in the user's snapshot, thus, updating the user's snapshot. In another embodiment, the snapshot is maintained in the work area 202 unchanged from that of the staging area 208, such that the same snapshot of the database may be used in each work area unaffected by changes made in the other work areas. This may be unique to the development application, where the work of individual users is kept separate from other user work areas.

In contrast, client application may be configured to keep changes in delta tables and base tables, which together emulate the staging area found in the development system. Tracking table 212 tracks the different changes proposed for the website as it is modified in response to changes proposed by each client work area and may be accepted by an authority of the client. The tracking table 212 is configured to track the various tables created, such as base tables, and also tracks the interrelationship among the various tables. The tracking table may keep track of the characteristics of the different tables such as the times and dates in which they are created, the interrelationships of the tables such as which base tables correspond with different delta tables, and other characteristics.

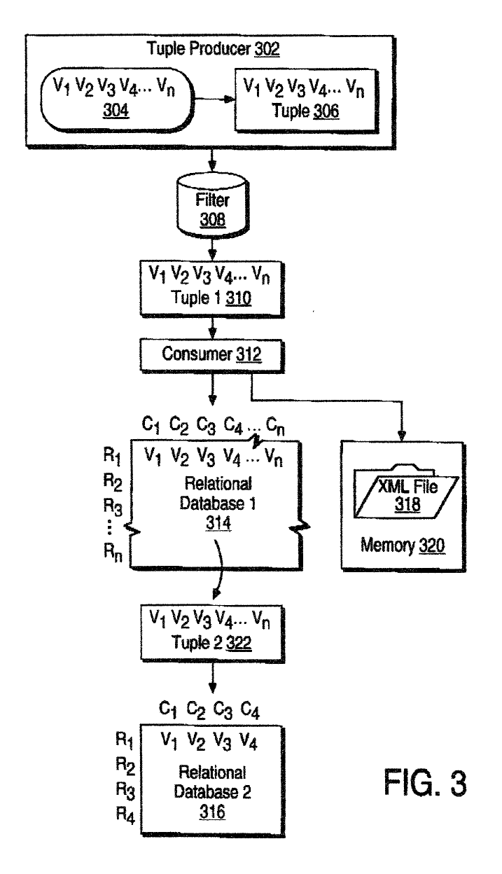

Referring to FIG. 3, an operational flow diagram of the system 100 (FIG. 1) is illustrated. The data deployment method illustrated is computer-implemented for deploying data within a website development environment. An example of such an environment is a development system made up of development workstations 102 and development server 104 connected by network 106 in FIG. 1. These deployments are internal to a development system, as opposed to external deployments, which would be deployments to destinations outside a development system. An example of an external deployment would be from a development system (such as 102, 104, 106 above) to production server 120 via network 122. The development system is configured to transfer data within the system in a useful manner in order to organize and track website development activities by concurrent users.

Information may be transferred and tracked within the development system in the form of tuples. Generally, tuples are ordered sets of particular elements. More specifically to the invention, tuples are standard sets of data that define the proposed changes to a website by a work area. For example, each tuple may include the following information fields:

Path: An area-relative path name of the file associated with a key-value pair (see below.

Key: The name of the extended attribute key (also known as the extended attribute class). For example, “News-Section” is the key of the extended attribute “News-Section: Sports.”

Value: A data value for the item stored in the tuples' Key field. In the above example, “Sports” is the value. Thus, a key-value pair includes a key and an associated value.

State: The status of the tuple. For example, a proposed change to a website represented by a tuple can be characterized as “new,” “modified,” “deleted” or “not present.” If information is unchanged for the website, the term “original” may characterize the state of such unchanged information.

The use of tuples in deploying data both internally and externally allows a website maintenance application to track data deployments throughout the system 100 (FIG. 1). Tuples may be produced in the system where data is located, the location where it is to be deployed or somewhere in between. For example, information may be deployed from the work area 202 to its associated delta table 206. In this situation, a tuple producer 302, which may in fact be the work area 202 itself, may package the data as a tuple and send it to a tuple destination 312, such as a database or other storage area, staging area, and may be eventually transferred to a base table, delta table, etc. of a client application. The tuple can then be transferred to a relational database 314, such as the base table 210 of the staging area 208, for storage. The mapping of tuples in such a relational database may be automatically triggered by the action of storing the tuples.

One such tuple format is illustrated below. In this example, Tuple 1 is for a “News-Section: Sports” extended attribute from the file “docroot/news/front.html”. Tuple 2 is for the “Locale: SF” extended attribute from the same file. Once configured into the tuple format, the tuples can be deployed into the specific destination, such as a base table, a delta table, or other storage mechanism, or to a production server, using section and formatting rules of deployment discussed below.

| Tuple Sample | | |
|---|---|---|
| Attributes | Tuple 1 | Tuple 2 |
| Path | docroot/news/front.html | docroot/news/front.html |
| Key | News-Section | Locale |
| Value | Sports | SF |
| State | Original | Original |

As mentioned, the relational database 314 may be the base table 210 of the staging area 208, which stores all information related to the base website information. As another example, relational database 314 may store a work area's delta table, such as the delta table 206, which stores the changes made by the work area 202. The tuple may also be sent to memory 320 and stored in an XML file 318. This could, for example, represent storage of the snapshot of the website in file storage 204 of the work area 202. Tuples may also be transferred among relational databases 314, 316. This could represent the transfer of data from delta table 206 to base table 210, such as when a submission of changes is made from a work area to a staging area. Using this system of data deployment, information can easily be transferred between work areas and staging areas so that website contributions can be organized and tracked.

A tuple may also be passed through a filter such as in filter 308. The filter may be a software module placed at any point of the system, which reads, modifies and sends tuples. Thus, tuples can be modified anywhere in the system. A filter may alter certain attributes of tuples and may have an expression for transformation of the tuples. For example, one may assume a particular Key is a particular persons' age in years at a particular point in time. A filter may convert all such Keys to a range of ages, thus associating each person with an age group rather than a specific age. According to the invention, the ability to filter or modify tuples allows the system to automatically configure versions of content by modifying a tuple information such as extended attributes and other information. This allows auto-synchronization with the database, storing data automatically upon certain events. Tuples may also be the baseline for data transmissions within a client application, where they are preserved in the delta and base tables in the client database.

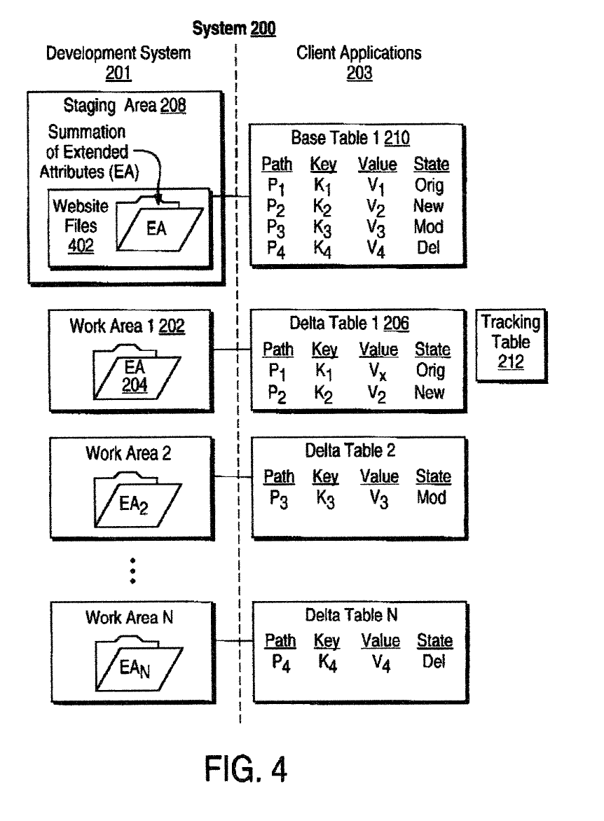

Referring to FIG. 4, a block diagram of storage features of a website development system of FIG. 2 is illustrated in more detail. Staging area 208 includes website files 402 which may include a summation of the extended attributes contributed by the different work areas. Such a summation is reflective of the resulting integrated effort produced by a collaboration of end user work created in work areas. As discussed above, in one embodiment, the system 200 is divided up into separate sections, the development section 201 where content is created and maintained in conjunction with a development server, and client applications 203 where content is created and maintained in conjunction with a separate client application as discussed above. In either application, the control of the changes made to content is located in different locations. The client applications may also depend on content maintained in staging area 208 containing integrated content files in the development system in order to keep its base table 210 updated. In one embodiment, the staging area may be the dominant location where fundamental changes reside, such as templates, unchanging content, and other information. Depending on the configuration, either the work areas or the client application, or both, may produce content for ongoing maintenance of website files. The work areas 202 and delta tables 206, located in database 140 of FIG. 1, may be indirectly related, where changes may be recorded in either location depending on the system configuration.

According to the invention, the extended attributes may be automatically extracted from the corresponding files, converted to tuples by a tuple producer and stored in the staging area 208. The tuples stored in the staging area 208 may be organized in base table 210 and versions of website tracked in tracking table 212. The base table 210 keeps track of the path, key, value and state of information, e.g., extended attributes converted to tuples, related to a website. As can be seen in base table 210 of FIG. 4, the state can include original designation (i.e., “Orig”), new designation (i.e., “New”), modified designation (i.e., “Mod”) and deleted designation (i.e., “Del”). The base table 210 can also include fields where information is not present.

Work area 202 may include extended attribute files 204 that contain information related to the contributions of a user in work area 202 to a website. The extended attributes may be converted to tuples. Delta table 206 organizes the website information, such as the tuples, related to work area 202 with respect to the base website. For example, in the path P₁, information is contained that is original, or in other words, unchanged from the original website snapshot.

In operation, a work area 202 can receive a snapshot of a database from base table 210, which includes all relevant information of a website. While working on the website, work area 202 will track changes made by a user in delta table 206. Information received from the base table 210 will then be modified by changing the path, key, value or possibly the state of the information. Once a work area has completed a task, it can submit a tuple to the staging area for recordation of the changes. According to the invention, the changes may be recorded on the base table 210. The change may be also recorded in tracking table 212, which dynamically tracks the changes being made by the workstation.

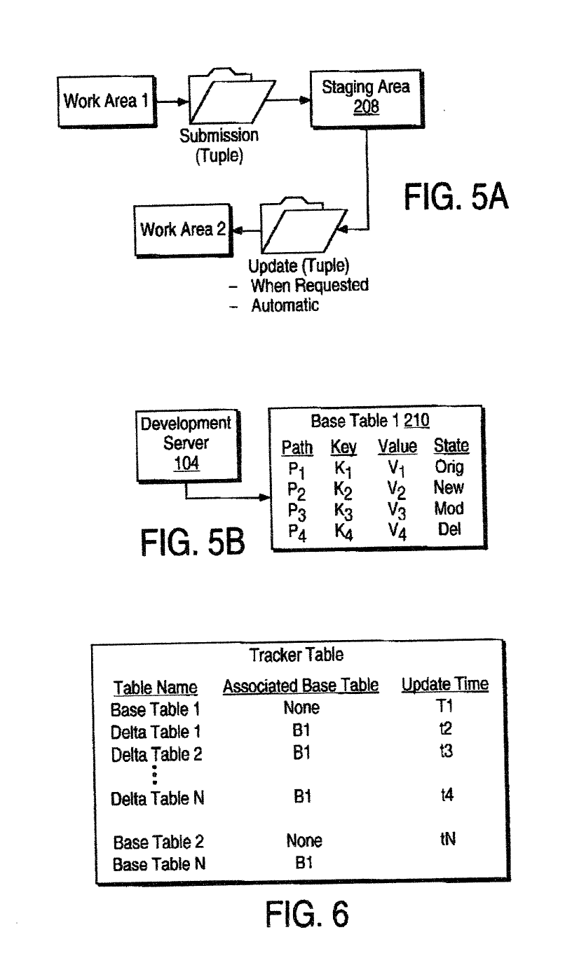

Referring to FIG. 5A, which is a more detailed diagram of the staging area 208, a work area can receive an update, sent in the form of tuples, in order to update the snapshot of the website in which a user is working. A development system can be configured to update the work area, for example, when requested by a user. In a preferred embodiment, updates to a work area are limited to information that has been submitted and approved for the final website. This can be done either automatically or in response to a request from a work area. This feature allows a system to maintain consistency so that all work areas are modifying a website using the same snapshot. Referring to FIG. 5B, a diagram of the relationship between a development server and a base table are illustrated. The base table 210 may contain tuple information that may be updated from the development server, such as from a staging area.

Referring to FIG. 6, a tracker table for use in tracking internal deployments is illustrated. The tracker table is a registry of tables that exist in the development system. The tracker table, for example, may keep track of the table names, such as the base or delta tables, the associated base table and the time in which an update was made. For example, as illustrated FIG. 4, delta table 206 is associated with base table 210 and, within the tracker table, would be represented as such. Using the tracker table, all changes made to web content may be maintained in memory for use by the system.

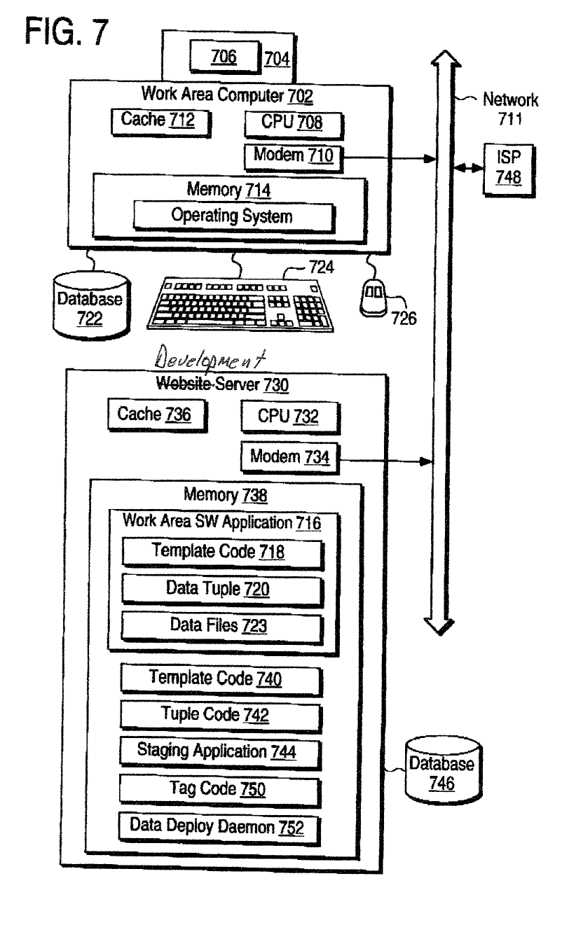

Referring to FIG. 7, a block diagram of a system employing a deployment application in accordance with the invention is illustrated. Such a deployment application is discussed in connection with a website development and maintenance solution as discussed above. The system includes a work area computer 702 connected to a monitor 704, which has a display 706 for displaying data to a user. The work area computer 702 includes a CPU 708 for controlling the inter-workings of the computer and a modem 710 connected to a network 711 for sending information to other destinations. The work area computer 702 further includes cache 712 for storing frequently used data. Memory 714, controlled by CPU 708, can be a conventional memory and can be a random access memory (RAM), a dynamic random access memory (DRAM), a static random access memory (SRAM), or any other memory configured to store and transfer digital data therefrom. The work area may also be defined as a collection of directories located on the development server, thus, not a separate computer in and of itself. Thus a work area may be defined merely as a set of files that a user at a development computer has authority for access.

If on a separate computer, it will be apparent that the computer 702 is conventional and that various modifications may be made to it. Also communicating with work area computer 702 is an optional database 722 for storing data that is easily accessed by a user. Data can optionally be stored in data files 723, which gives a user an organized way to store data. Memory 714 may also include a conventional operating system, such as Windows, for receiving content fro the development server to further develop and maintain. Work area computer 702 also includes a keyboard 724 and mouse 726 that allow a user to input data.

The website building system of FIG. 7 further includes a development server 730 having a CPU 732 for controlling the inter-workings of the server 730 and a modem 734 connected to network 712 for transferring data using the network 712. The development server 730 includes memory 738 that includes work area software application 716 that includes template codes for creating and storing templates used for displaying data. These templates define the displays used on the website, so that a user having a graphic user interface (GUI) can read the data displayed in the selected template format. Also stored in the memory 714 is data tuple code 720 for storing and transferring data in the tuple format. The server 730 further includes a cache memory 736 for storing frequently used data and a conventional memory 738. This cache 736 may reside in software in the memory 738 as well. Thus, it will be apparent that the server 730 is a conventional server and that various modifications may be made to it. Memory 738 may include template code 740 for storing and creating templates to be used on a website. The server 730 may further include tuple code 742 for storing and transferring data in a tuple format. Tuple code may be a software application configured to deploy data. Further included is a staging application 744 for staging contributions to the website by multiple work areas. The staging application 744 can configure the template code and tuple code for displaying data on a website in a given template format. Also included is an optional database 746 for storing data to be accessed by the development server 730. ISP 748 may also be included in the system of FIG. 7 to allow the work area computer 702 and development server 730 to exchange data via the Internet, another example of network 711. The data deploy daemon 752 may be a software application that is configured to deploy data based on certain trigger events. The function of the daemon is described in more detail below.

As discussed above, data deployment can occur in response to or otherwise subsequent to certain system event triggers. In response to such events, delta tables and base tables may be updated according to the particular event. Some events that may be associated with a website development system are illustrated in Table A. The delta tables and base tables are expressed in rows and columns, where the respective data is stored. Also, when a table is created, blank areas may be created in order to act as placeholders for future data.

TABLE A

| System Event | Delta Table Action | Base Table Action |
|---|---|---|
| Create Branch | None. | Build empty Base tables. |
| Create Work Area | Build Delta tables. | None. |
| Delete Branch | Drop Delta tables. | Drop Base tables. |
| Delete Work Area | Drop Delta tables. | None. |
| Modify DCR (Data Content | Update or insert a new row. | None. |
| Record) | | |
| Add DCR | Insert a new row. | None. |
| Delete DCR | Insert or update the Not | None. |
| | Present Row. | |
| Submit Modified DCR | 1. The previous staging row | Update the staging row. |
| | is propagated to all work | |
| | areas except the submitting | |
| | work area. | |
| | 2. Delete previous staging | |
| | row from submitting work | |
| | area. | |
| Submit Added DCR | 1. The placeholder row | Update the staging row. |
| | marked NOT PRESENT is | |
| | propagated to all work areas | |
| | except the submitting work | |
| | area. | |
| | 2. Delete the placeholder row | |
| | from the submitting work | |
| | area. | |
| Submit Deleted DCR | 1. The previous staging row | Update the staging row. |
| | is propagated to all work | |
| | areas except the submitting | |
| | work area. | |
| | 2. Delete previous staging | |
| | row from the submitting | |
| | work area. | |
| Get Latest (work area | Rebuild the delta tables. | None. |
| content) | | |
| Copy To (any area) | Rebuild the delta tables. | None. |
| Rename Work Area | 1. Drop the old delta tables. | None. |
| | 2. Regenerate new delta | |
| | tables. | |
| Rename Branch | None. | 1. Drop the old base tables. |
| | | 2. Regenerate new base |
| | | tables. |
| Rename Directory | Regenerate new delta tables. | None. |
| Rename File | 1. Delete the row for the old | None. |
| | file name. | |
| | 2. Add a row for the new file | |
| | name. | |
| Move File | 1. Delete the row for the old | None. |
| | file name. | |
| | 2. Add a row for the new file | |
| | name. | |
| Revert | Use the data from the earlier | None. |
| | version of the file to update | |
| | or insert a new row. | |

One embodiment of the invention is directed to the deployment of certain information upon the occurrence of particular events, usually when precious data is produced. While a user is working in the work area, certain events may trigger certain data to be stored in a particular location. Referring to the table above, a list of events along with corresponding actions to the data tables are tabulated. The events listed, such as creating branches and creating work areas, trigger actions to occur in the delta table and base table when appropriate. Once triggered, data is captured and stored in appropriate locations. In this embodiment, these triggers are synchronized to automatically deploy data content records to a database whenever an application user creates or changes a data content record while developing or maintaining a website. As discussed above, deployments may be of at least two different varieties, depending on what system controls the changes made to the website servers. If a client application exists, the control for day to day development and maintenance of web content resides with the client. Changes in the staging areas may be transferred to the base tables located in a client database to update fundamental content, and changes from work areas communicating with the client application may make further changes, which are stored in delta tables. If, however, there exists no separate client application, then control resides in the development server, and changes made in work areas communicating with the development server are submitted to staging area (similar to the base tables) for integration with other content.

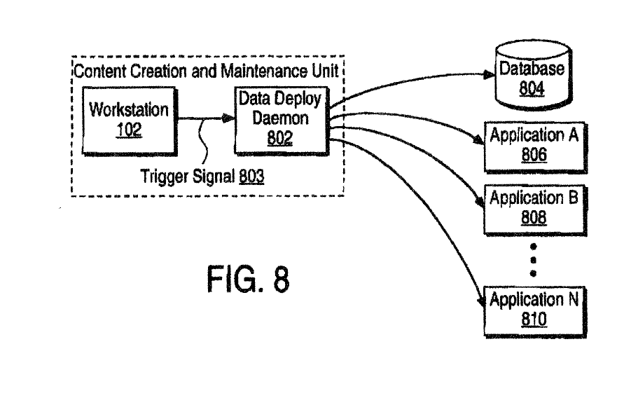

Referring to FIG. 8, another embodiment of a system configured to develop and maintain websites is illustrated. A workstation 102 such as that illustrated in FIG. 7 is included for the development and maintenance of content. Once the content is designated for deployment, the data deploy daemon 802 may be configured to deploy the data in a manner that preserves the data properly and in a way that is useful for the development and maintenance of a website. Upon such a deployment, a trigger signal 803 may be sent to the daemon in order to trigger the deployment of data to locations such as delta tables or base tables located within database 804, or to a variety of applications 806, 808, 810 that may need or desire the data. The daemon may be a software application located in a device in which it can be executed, it may be a simple or complex hardware or firmware application, or it may be an event server configured to intelligently deploy the data according to certain criteria.

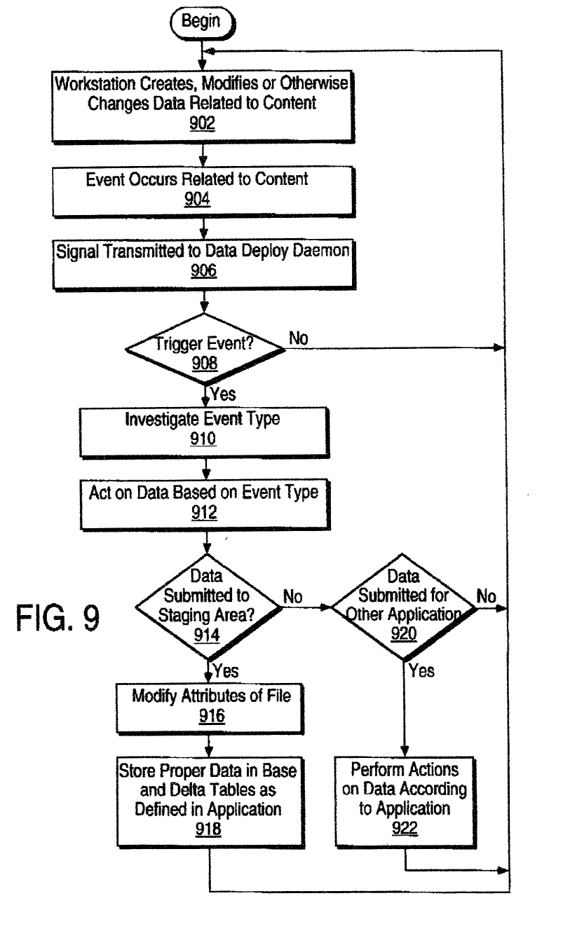

Referring to FIG. 9, a flow diagram illustrating an example of how trigger events may improve the deployment of data is shown. After beginning the process at step 901, e.g., starting up the workstation system, a user may create, modify or otherwise change data related to the content, including the content itself, in step 902. Then, an event may occur in step 904 that is related to the content. A signal may then be transmitted to the data deploy daemon in step 906, indicating the possible occurrence of a trigger event. A determination is then made in step 908 by either the daemon or the workstation of whether the event is indeed a trigger event. If it is not a trigger event, the process begins again at step 901, or the system merely continues operation. If a trigger event actually occurs, the type of event is then investigated in step 910. This may be accomplished by reading the signal, which may indicate the actual type of event that has occurred. A mechanism may exist within or otherwise associated with the daemon, such as a look-up table or other similar device having action items to be performed in response to the trigger event. Such a device may include tabled information such as that shown in Table A. Once the event is identified, action may be taken in step 912 based on the event type.

For example, a query may be made as step 914 of whether content or other data was submitted to a staging area from a work area. If this was in fact the event that occurred, the attributes of the file may be modified in step 916 in order to distinguish the new content submitted to the staging area from other versions that may have been submitted at an earlier time or by a different workstation. The data may then be stored in a database in step 918 within base tables or delta tables as defined in the particular client application to which the delta and base tables are associated. The process may then return to the beginning at step 901, or possibly progress to another activity.

Still referring to FIG. 9, if at step 914 it is determined that the action is not a submission to a staging area, it may be an event that triggers another type of action. Then, the process may go from step 914 to step 920, where it is determined whether data was submitted for another application. If not, the process may return to the beginning, step 901, or progress to another activity. If the data was submitted for another application, perhaps a predetermined or predefined application, actions may be performed on the data in step 922 according to the parameters of the application. A table of information such as that in Table A may be utilized in such a step.

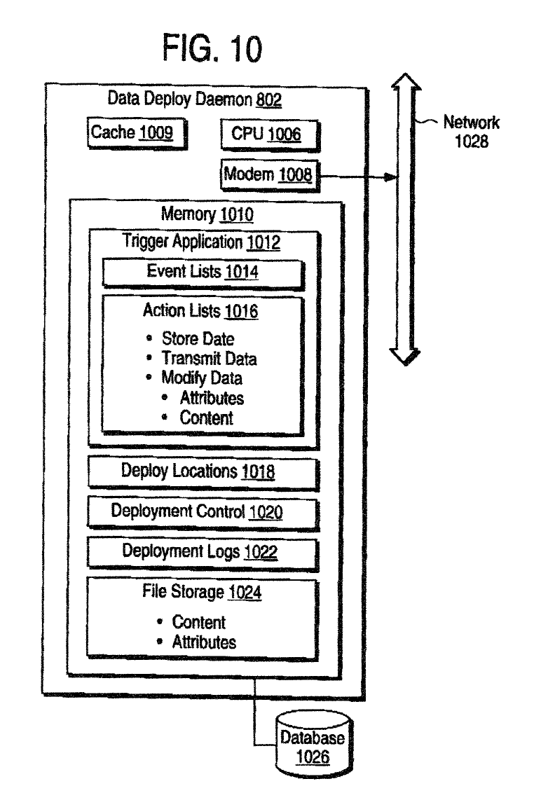

Referring to FIG. 10, an illustration of one example of a data deploy daemon 802 is shown, embodied in a programmable device such as an event server. The daemon may include a CPU 1006 that is configured to execute software code that defines or governs the functions of the daemon. The daemon may include a modem 1008 for communicating with a network 1028 or other system. The daemon may also utilize other types of communication mediums such as DSL, T1 connection, wireless connections, and other communication configurations. The demon may also include a cache memory 1009 or other type of memory such as persistent memory (not shown) for temporarily storing software code for easy and fast access by the CPU. Main memory 1010 may be configured with software code for deploying data according to trigger events. Trigger application 1012 may be configured with event lists 1014 that define particular events that may occur that trigger certain deployments or other actions. Main memory may also include some type of action lists 1016, that define actions that occur in response to such trigger events. Examples may include the storage of data or the transmission of data from one location to another. Other examples may include the modification of data such as attributes, extended attributes and actual content that is created or maintained in a system. Upon execution of this code, a trigger event may be responded to by the daemon by performing actions that are associated with a particular event.

Deploy location software code or data 1018 related to deployment locations may also be included in daemon 802 for defining deployment locations to which date is transmitted. The CPU may execute such code in response to a trigger event that directs data to be deployed to a particular destination. The deploy code would define such a path to be taken to deploy the data. Deployment control software code or data 1020 may also be included in memory 1010 to define other control aspects of a deployment, such as those described in connection with the functional flow diagram shown in FIG. 9.

Deployment logs software code or data 1022 may be configured to maintain records of deployment details. Records may include times and dates when a deployment occurred, source and destination locations of deployments, and other information related to deployment that may be useful in an application configured to develop and maintain websites or other similar applications. When executed by the CPU, such code may be configured to record such logs in a useful manner.

File storage 1024 may be included in main memory 1010 for storing content, attributes, extended attributes and other data. Database 1026 may also be accessible by daemon 802 for storing and retrieving data for use in deployment and in other functions. Either main memory 1010 or database 1026 may be used by such a daemon for storing and retrieving data for use in a system wherein the daemon is employed.

In general, the invention may include the utilization of dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, such implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively.

The apparatus and method include a method and apparatus for automatically deploying data within and synchronously with the operation of a software application. Although this embodiment is described and illustrated in the context of a software application for developing Internet websites, the scope of the invention extends to other applications where preservation of data at either a data source or destination is useful. Furthermore, while the foregoing description has been with reference to particular embodiments of the invention, it will be appreciated that these are only illustrative of the invention and that changes may be made to those embodiments without departing from the principles of the invention, the scope of which will be defined in subsequent utility applications claiming priority based on this application.

1. A system for automatically deploying data in a computer network comprising:
a retrieval mechanism configured to automatically retrieve and deploy data to a destination upon occurrences of certain events from different sources associated with a website development and maintenance application during its use and operation; and
a storage mechanism configured to store data in a manner that is transparent to a user upon the occurrence of an event.
